(19) United States
(12) Patent Application Publication
(10) Pub. No.: US 2003/0107648 A1
(43) Pub. Date: Jun. 12, 2003

(54) Surveillance system and method with adaptive frame rate

(76) Inventors: Richard Stewart, San Diego, CA (US); Keith Trahan, San Diego, CA (US); David Chesavage, San Diego, CA (US); Sean Casey, Solana Beach, CA (US); Michael Rome, San Diego, CA (US); Chris Kokinakes, Encinitas, CA (US)

Correspondence Address: QUALCOMM Incorporated, Attn: Patent Department, 5775 Morehouse Drive, San Diego, CA, 92121-1714, US

(21) Appl. No.: 10/017,190

(22) Filed: Dec. 12, 2001

(51) Int. Cl. H04N 7/18

(52) U.S. Cl. 348/143; 348/152; 348/154; 348/155; 375/240.01

(57) ABSTRACT

A surveillance system includes video surveillance cameras that are in various locations sought to be monitored. Each camera is associated with a variable frame rate that is faster when motion is detected in the location and slower when little or no motion is detected, to improve resolution when needed. A system hub receives video feeds from the cameras and sends them on to wireless clients upon client request.

### I. FIELD OF THE INVENTION

The present invention relates generally to surveillance systems.

### II. BACKGROUND OF THE INVENTION

Surveillance systems are used in a wide number of applications to promote security. Typically, a surveillance system includes one or more video cameras that are mounted in a location sought to be monitored. The cameras send video footage to central monitoring areas where the video is observed by security personnel, or stored for later viewing, or both.

As recognized by the present invention, existing surveillance systems suffer several drawbacks. One drawback is that the resolution of most systems is less than what might be desired, making it harder for security personnel to recognize people imaged by the system. Increasing the resolution of surveillance video, however, requires increasing the rate at which video frames are updated, i.e., it requires generating more data. This in turn increases the burden on the video storage resources of the system. Moreover, as recognized by the present invention the higher the data rate the more stressed the capacity of a transmission system which might be used to send the data elsewhere.

Specifically, as mentioned above the surveillance video typically is fed to a monitoring location, which means that security personnel must be present at the monitoring location to view the video in real time. As recognized by the present invention, however, it is not always practical for security personnel to be tied down to one location. Rather, it is often desirable that security personnel patrol surveilled premises, but existing surveillance systems do not provide real time video to roaming security personnel. The present invention understands that viewing surveillance video in real time can be an important and valuable tool for patrolling security personnel.

However, as still further recognized herein, in some applications it might be desirable to maintain surveillance video images in a secure system, to prevent eavesdroppers from accessing the video. This requirement might be further heightened in the case of a surveillance system that could provide video in real time to patrolling security personnel. Having made the critical observations discussed above, the present invention provides the below-disclosed solutions to one or more of the prior art drawbacks.

### SUMMARY OF THE INVENTION

A method for surveillance includes generating a video of a surveilled location using a camera, and dynamically establishing a frame rate of the video based on motion in the surveilled location. In this way, lower data rates are used when little or motion exists, to minimize the bandwidth requirements of a transmission system that might be used to transmit the video, while facilitating higher data rates when called for, i.e., when motion is detected.

In a preferred embodiment, the motion is identified based on changes between frames of the video. In another embodiment, the motion is identified using a motion detector at the location.

As contemplated herein, the video is transmitted, preferably after user authentication, to a mobile wireless receiver for display of the video on a terminal that is associated with the receiver. Indeed, the video can be transmitted to plural mobile wireless receivers, in real time if desired. Moreover, electronic or paper billing documents can be generated based on the transmitting act. Videos can be generated of respective surveillance locations for routing the videos to respective wireless receivers in response to user requests for videos.

In one non-limiting embodiment, the frame rate is a rate of processing and/or compressing entire frames. In another embodiment, the frame rate is a rate of processing and/or compressing only regions of an entire frames, that is, there is a variable amount of compression in different regions, such that one region might be compressed at a first rate and a second region might be compressed at a second rate different from the first rate, or not at all compressed.

In another aspect, a surveillance system includes a source that transmits surveillance video using wireless data transmission principles. A system hub receives the video from the source. At least one wireless receiver is in communication with the hub for receiving video from the hub.

In yet another aspect, a surveillance method includes disposing at least one video camera in at least one location to be surveilled, and using the video camera to generate a video feed. A frame rate that is associated with the feed is varied based at least in part on motion of at least one object at the location. The video feed is then transmitted in real time to at least one monitoring receiver over a wireless link.

In still another aspect, a system includes plural video surveillance cameras disposed in plural locations sought to be monitored, with at least one of the cameras having a variable frame rate that bears a relationship to motion in the respective location. At least one system hub communicates with the cameras and receives signals therefrom. Plural client receivers are in wireless communication with the hub for receiving video streams therefrom.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a presently preferred surveillance system;

FIG. 2 is a flow chart of the overall logic of the frame rate algorithm; and

FIG. 3 is a flow chart of one non-limiting example of logic for establishing the frame rate in response to motion in a surveilled location.

### DETAILED DESCRIPTION OF THE PREFERRED EMBODIMENT

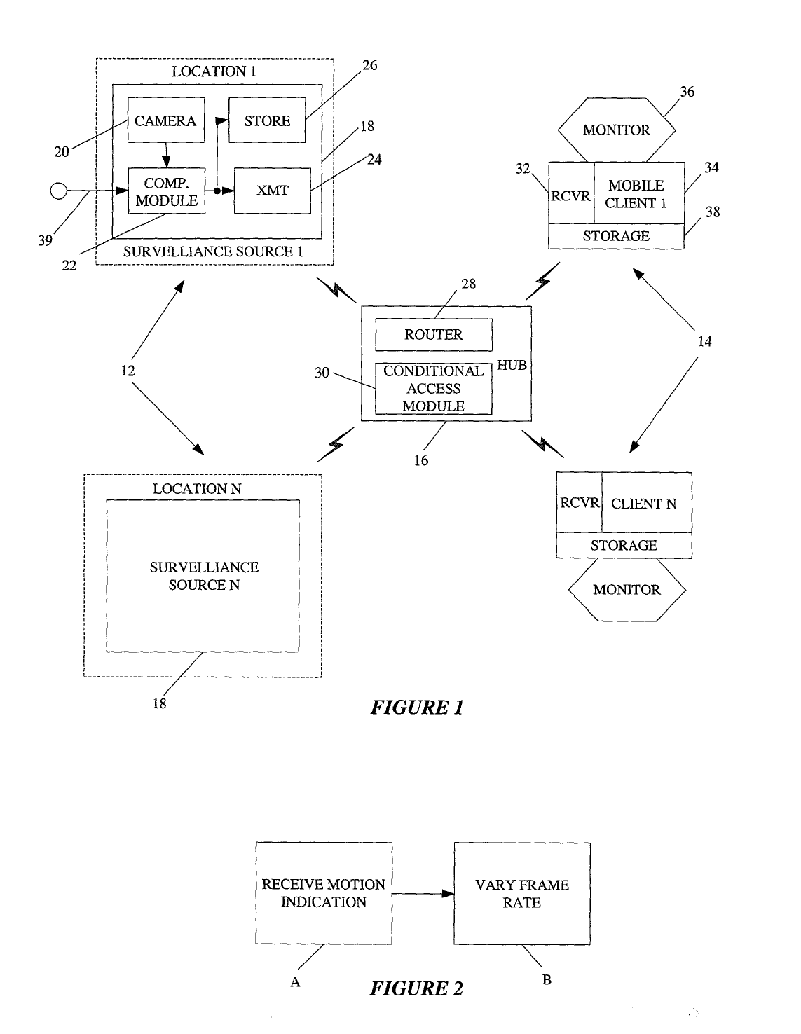

Referring initially to FIG. 1, a system is shown, generally designated 10, for effecting video surveillance in plural locations 12 and for selectively sending surveillance video, preferably in real time, to one or more requesting clients 14, which can be mobile or portable clients, via a system hub 16 preferably using wireless transmission principles known in the art.

As shown in FIG. 1, at least one respective surveillance video source 18 is disposed in each location 12. Taking the source 18 shown at the top of FIG. 1 as an example, the source 18 includes at least one video camera 20 which generates a video stream or feed composed of video frames. The generated video is sent to a compression module 22 that functions in accordance with the disclosure below to dynamically establish the frame rate and to compress the video. The compressed video is then sent to a transmitter 24, preferably a wireless transmitter, and if desired is also stored in a local storage 26.

According to the preferred implementation shown in FIG. 1, the transmitter 24 of each video source 18 sends video to the system hub 16 over a wired or wireless link. The hub 16 includes a router 28 that routes video streams to requesting clients 14 using a wireless link. The clients 14 can access the video streams by establishing communication with the hub 16 and authenticating themselves to a conditional access module 30 at the hub 16. That is, to access a particular stream a client 14 establishes communication with the hub 16 and requests a particular video stream from a client-selected location 12, with the conditional access module 30 permitting (or not) the client 14 to receive the selected stream, depending on the client's authentication. Consequently, access to the surveillance video streams generated by the sources 18 can be controlled by the hub 16 on a client-by-client basis.

Moreover, the conditional access module 30 can authenticate a source of video by, e.g., determining whether a source has properly digitally “signed” a video stream. In this way, a client can be assured that what he or she is viewing indeed comes from the desired source. With the above discussion in mind, it is to be appreciated that the conditional access module 30 essentially secures the link between source and client.

To provide a requested video stream to a properly authenticated client 14, the hub 16 transmits the video stream over a wireless link to the requesting client 14. Since the link is wireless, the client can be mobile, e.g., the client can be a portable laptop computer or other computing device that can be borne by a patrolling security guard, e.g., a data-enabled handset. To this end, each client 14 includes a wireless receiver 32, a local processor 34 receiving signals from the receiver 32, and a video monitor 36 that outputs video images. A local storage 38 can also be provided to store video streams.

In accordance with the present invention, the system 10 uses wireless data communication techniques such as TDMA, CDMA, WCDMA, or satellite communication systems such as Global Star®. In one non-limiting embodiment the system 10 uses Code Division Multiple Access (CDMA) principles and a CDMA over-the-air (OTA) communication air interface, which can include protocols such as are defined in but not limited to IS-95A, IS-95B, WCDMA, IX, IXCV, EV and DV, IS-2000, and others.

For instance, the wireless communication systems to which the present invention can apply, in amplification to those noted above, include Personal Communications Service (PCS) and the following digital systems: CDMA, WCDMA, and hybrid Time Division Multiple Access (TDMA)/CDMA technologies. A CDMA cellular system is described in the Telecommunications Industry Association/Electronic Industries Association (TIA/EIA) Standard IS-95. Other communications systems are described in IS-98 and in the International Mobile Telecommunications System 2000/Universal Mobile Telecommunications Systems (IMT-2000/UM), standards covering what are referred to as wideband CDMA (WCDMA), cdma2000 (such as cdma2000 1× or 3× standards, for example) or TD-SCDMA.

The present invention can be used with any wireless system. In general, wireless communication devices which can be incorporated in, e.g., each client 14 may include but are not limited to a wireless handset or telephone, a cellular phone, a satellite phone, a data transceiver, or a paging and position determination receiver, and can be hand-held, or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as “users” and “mobiles” in some communication systems.

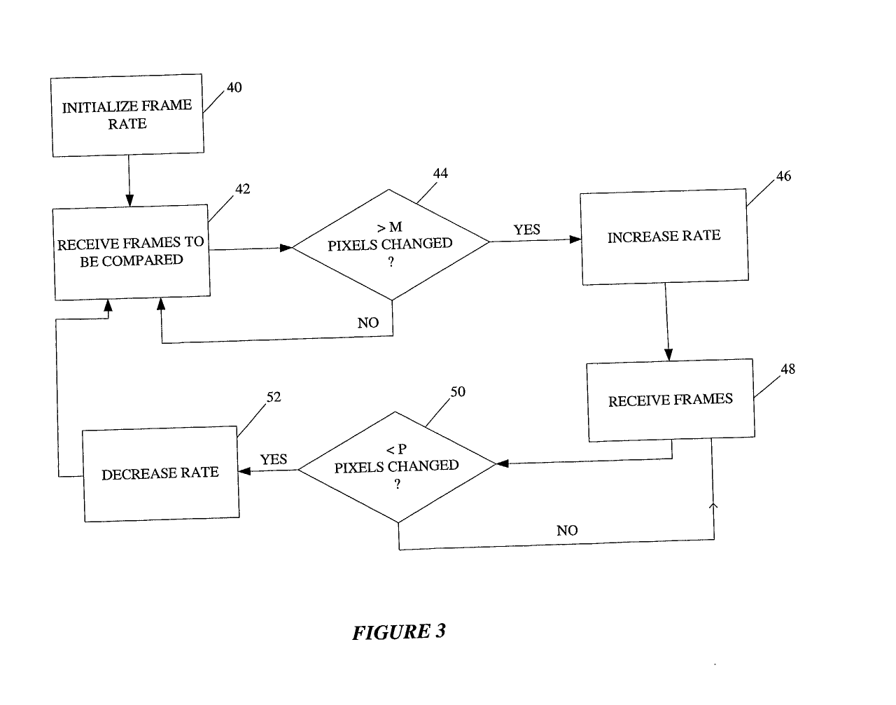

FIGS. 2 and 3 illustrate the structure of the logic of the compression module 22 as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer, controller, processor, etc.) to perform a sequence of function steps corresponding to those shown.

In other words, the logic may be embodied by a computer program that is executed by a processor within, e.g., the video source 18 as a series of computer- or control element-executable instructions. These instructions may reside, for example, in RAM or on a hard drive or optical drive, or the instructions may be stored on magnetic tape, electronic read-only memory, or other appropriate data storage device that can be dynamically changed or updated.

Commencing at block A in FIG. 2, an indication of motion in a location 12 is received. This indication might come, for example, from a motion sensor 39 (FIG. 1) that is disposed in the location 12 and that communicates with the module 22. More preferably, the indication of motion is derived from the video image itself, as discussed further below in reference to FIG. 3. At block B of FIG. 2, the video frame rate can be established, if desired, based on the amount of motion in the location 12. That is, the more motion, the faster the rate. When little or no motion is sensed, the video frame rate can be minimized to minimize the bandwidth requirements imposed on the wireless transmission system. The video is then compressed after the frame rate is established.

FIG. 3 shows one exemplary, non-limiting method to establish a video frame rate based on motion. Commencing at block 40, the frame rate can be initialized at a nominal value, e.g., at a minimum rate. Then, plural frames can be received at block 42 for comparison. The frames to be compared can be individual frames, either immediately adjacent to each other in the video stream or separated from each other by other frames. Or, frame composites can be used, i.e., the average pixel values from “n” frames can be compared on a pixel-by-pixel basis against the average pixel values from the preceding “n” frames. In undertaking the comparison, the entire pixel array can be considered, or only regions of the array, with a single frame rate being established or with different frame rates for different regions of the array being established, respectively.

Decision diamond 44 represents one comparison that can be made. Specifically, at decision diamond 44 it is determined whether the values for a predetermined number of pixels have changed. Other heuristics can be used, however, to determine whether motion exists in the location 12 based on a frame-to-frame comparison. For instance, motion might be indicated only if a threshold percentage of pixels has changed in each of three or more successive frames.

If the test at decision diamond 44 is positive, meaning that motion above a predetermined threshold has been sensed, the logic moves to block 46 to increase the frame rate of the entire frame or, if regions of the frame are being compared, of the respective region. The frame rate can be increased by a single discreet value or it can be increased in proportion to the amount of motion sensed, i.e., in proportion to the number of pixels that have changed.

Additional frames can be received at block 48 and compared to each other at decision diamond 50 to determine whether motion has stopped or otherwise fallen below a predetermined threshold. For example, it can be determined whether less than a predetermined number of pixels has changed, and if so the frame rate is decreased at block 52. FIG. 3 shows that the logic continues to loop as the video stream is generated. Electronic or paper billing documents can subsequently be generated to bill a client 14 for receiving video feeds. The billing information can be collected by the hub 16 and securely transmitted to a billing authority.

While the particular SURVEILLANCE SYSTEM AND METHOD WITH ADAPTIVE FRAME RATE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

What is claimed is:

1. A method for surveillance, comprising:
generating at least one video of at least one surveilled location using at least one camera; and
dynamically establishing a frame rate of the video at least partially based on motion in the surveilled location.

2. The method of claim 1, comprising identifying the motion based on changes between frames of the video.

3. The method of claim 1, comprising identifying the motion using a motion detector at the location.

4. The method of claim 1, comprising transmitting the video to at least one mobile wireless receiver for display of the video on a mobile terminal.

5. The method of claim 4, comprising transmitting the video to plural mobile wireless receivers.

6. The method of claim 4, comprising transmitting the video to at least one mobile wireless receiver in real time.

7. The method of claim 4, comprising generating at least one electronic or paper billing document based on the transmitting act.

8. The method of claim 4, wherein the transmitting act is undertaken in response to a successful authentication.

9. The method of claim 1, comprising compressing the video.

10. The method of claim 1, comprising generating plural videos of respective surveillance locations and routing the videos to respective wireless receivers in response to user requests for videos.

11. The method of claim 1, wherein the frame rate is a rate of processing and/or compressing entire frames.

12. The method of claim 1, wherein the frame rate is a rate of processing and/or compressing only portions of an entire frames.

13. The method of claim 4, comprising providing at least one conditional access module in a link between the location and receiver to secure the link.

14. The method of claim 13, wherein the link is secured by authenticating at least one of: a source of the video, and the receiver.

15. A surveillance system, comprising:
at least one source transmitting surveillance video using wireless data transmission principles;
at least one system hub receiving the video from the source; and
at least one wireless receiver in communication with the hub for receiving video from the hub.

16. The system of claim 15, wherein the wireless data transmission principles are CDMA principles.

17. The system of claim 15, comprising plural sources and plural receivers.

18. The system of claim 15, wherein the source includes:
at least one frame rate establishing module including logical structure to establish a video frame rate based at least in part on motion in a surveilled location.

19. The system of claim 18, wherein the frame rate is established based on changes between frames of the video.

20. The system of claim 15, further comprising a mobile terminal associated with the receiver and displaying video thereon.

21. The system of claim 18, wherein the frame rate is a rate of processing and/or compressing an entire video frame.

22. The system of claim 18, wherein the frame rate is a rate of processing and/or compressing only a portion of a video frame.

23. The system of claim 15, wherein the hub secures a link between the source and receiver.

24. The system of claim 23, wherein the link is secured by authenticating at least one of: the source, and the receiver.

25. A surveillance method, comprising:
installing at least one surveillance camera in at least one location to be surveilled;
using the surveillance camera to generate a video feed by generating video frames;
varying a frame rate associated with the frames based at least in part on motion of at least one object at the location; and
transmitting the video feed in real time to at least one monitoring receiver over a wireless link.

26. The method of claim 25, wherein the frame rate is a rate of processing and/or compressing an entire video frame.

27. The method of claim 25, wherein the frame rate is a rate of processing and/or compressing only a portion of a video frame.

28. The method of claim 25, comprising generating at least one billing document based at least in part on the transmitting act.

29. The method of claim 25, comprising identifying the motion based on changes between frames of the video.

30. The method of claim 25, comprising transmitting the video feed to at least one mobile wireless receiver for display of the video on a mobile terminal.

31. The method of claim 30, comprising transmitting the video to plural mobile wireless receivers.

32. The method of claim 25, wherein the transmitting act is undertaken in response to a successful authentication.

33. The method of claim 25, comprising compressing the video feed.

34. The method of claim 25, comprising generating plural video feeds of respective surveillance locations and routing the videos to respective wireless receivers in response to user requests for video feeds.

35. A system, comprising:
plural video surveillance cameras disposed in plural locations sought to be monitored, at least one of the cameras generating video being associated with a variable frame rate bearing a relationship to motion in the respective location;
at least one system hub communicating with the cameras and receiving signals therefrom; and
plural client receivers in wireless communication with the hub for receiving video streams therefrom.

36. The system of claim 35, wherein the hub is in wireless communication with the cameras.

37. The system of claim 35, wherein the wireless data transmission principles are CDMA principles.

38. The system of claim 35, wherein the frame rate is established based on changes between frames of a video.

39. The system of claim 35, further comprising a respective mobile terminal associated with each receiver and displaying video thereon.

40. The system of claim 35, wherein the frame rate is a rate of processing and/or compressing an entire video frame.

41. The system of claim 35, wherein the frame rate is a rate of processing and/or compressing only a portion of a video frame.

42. The system of claim 35, wherein the hub secures a link between at least one camera and at least one receiver.

43. The system of claim 42, wherein the link is secured by authenticating at least one of: the camera, and the receiver.
